(19) United States
(12) Patent Application Publication
(10) Pub. No.: US 2018/0330003 A1
(43) Pub. Date: Nov. 15, 2018

(54) SYSTEM AND METHOD TO STORE WEB ADDRESSES AS IMAGES

(71) Applicant: Michael A. Pavarini, White Plains, NY (US)

(72) Inventor: Michael A. Pavarini, White Plains, NY (US)

(21) Appl. No.: 15/975,285

(22) Filed: May 9, 2018

Related U.S. Application Data
(60) Provisional application No. 62/503,438, filed on May 9, 2017.

(51) Int. Cl. G06F 17/30; G06F 3/0481; G06F 17/22

(52) U.S. Cl. CPC G06F 17/30882; G06F 3/04817; G06F 17/30047; G06F 17/3089; G06F 17/2235

(57) ABSTRACT

A content management system (CMS) that allows a user to populate a plurality of hyperlink placeholders with a desired hyperlink such that the desired hyperlink presents an icon image corresponding to the domain name structure of the hyperlink location, or unified resource locator (URL). The system may automatically query the hyperlink locations to return icons associated with the hyperlink locations, based on the domain name structure of the requested URLs.

### CROSS-REFERENCE TO RELATED APPLICATION

This application claims the benefit of priority of U.S. provisional application No. 62/503,438, filed May 9, 2017, the contents of which are herein incorporated by reference.

### BACKGROUND OF THE INVENTION

The present invention relates to internet content management, and more particularly to hyperlinks and image based internet searches.

Current content management systems (CMS)s designed to manage hyperlinks presently available do not permit visualizing hyperlinks as images, rather such hyperlinks are presented as text on a webpage, which the user must read in order to identify a hyperlink of interest.

Similarly, other CMSs presently available in most cases lack unity between browsers. That is, they do not present information in a consistent manner across browser platforms. In addition, other CMSs are not always supported consistently across multiple devices. That is, their underlying operating systems OS do not support cross device compatibility. With regards to all that is currently available, none of these CMSs, offer visual representations of the content, other than text on a webpage.

While some image based browsers present a screen capture image of a destination hyperlink, or the shortcut icon, also known as the favicon, the content within these representations when presented as an icon image, is frequently too small, or too difficult for the user to distinguish between websites, or too generic in the case of shortcut icons, or favicons.

As can be seen, there is a need for an improved content management system that combines ease of use, with cross platform and cross device functionality.

### SUMMARY OF THE INVENTION

In one aspect of the present invention, a content management system (CMS) provides a user configurable icon based browser user interface. The CMS includes a server configured to serve web pages to a plurality of system users. A database is configured to store a plurality of hyperlinks for a plurality of web destinations and an icon image value associated with each of the plurality of hyperlinks. This icon image value is determined by the hyperlink's domain name structure and is then used to retrieve an image in relation to the hyperlink, from an image database, wherein plurality of images are given unique values in the database by the domain name structure for the given hyperlink representation. The CMS system provides an image based browser window to present a graphical user interface having a plurality of hyperlink placeholders disposed in a spaced apart relation, wherein each of the plurality of hyperlink placeholders are user configurable to present an icon image for a selected one of the plurality of hyperlinks, as well as a hyperlink destination, that when selected connects the user to the requested web destination corresponding to the hyperlink.

The CMS may also include a link editor control in each of the plurality of hyperlink placeholders, that when activated, displays a link editor on the graphical user interface, the link editor providing controls for the user to designate a hyperlink and an icon image value for the selected hyperlink placeholder. The link editor may provide a plurality of fields for designating a user selected hyperlink and an icon control to specify the unique icon for association with the selected hyperlink placeholder.

In some embodiments, the CMS may also include an icon image database search interface that is activated in response to selection of an icon search control. The interface displays web destination representations corresponding to the user search input as icon images, as well as image values for those icons, corresponding to the returned destinations domain name structure. The database search interface may also include a web destination selection control for each of the one or more web destinations shown in the database search, that when activated, selects the web destination and the corresponding icon image value, for display in the link editor.

In some embodiments, the link editor may include an update control, that when activated stores the desired hyperlink and icon image value to be used for navigation and display in the selected hyperlink placeholder of the image based browser and provides a control, that when selected by the user opens the web destination specified by the hyperlink corresponding to the retrieved icon image, having a value determined by the domain name structure of the desired hyperlink.

In other embodiments, the CMS may, responsive to activation of a share control, permit the user may share a configured image based browser with one or more users of the CMS.

In yet other embodiments, responsive to activation of an off control, the edit control in each of the one or more placeholders is disabled.

These and other features, aspects and advantages of the present invention will become better understood with reference to the following drawings, description and claims.

### BRIEF DESCRIPTION OF THE DRAWINGS

FIG. 1 is a flowchart illustrating a process flow for utilizing the present invention.

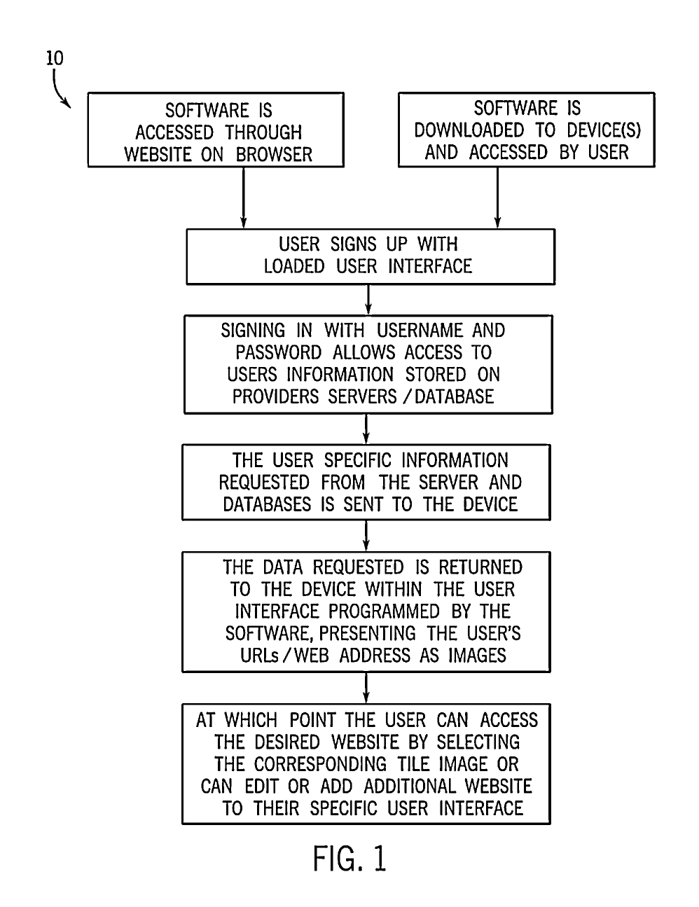

FIG. 2 is a representative user authentication and credentialing screen.

FIG. 3 is a representative browser window graphical user interface presenting a plurality of user specified graphical controls for icon based web browsing.

FIG. 4 is a representative icon image search window.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

As stated above, cross-browser and cross-device management of visualized representations of hyperlinks is not presently available, other than text on a webpage.

Broadly, embodiments of the present invention provide a CMS, and method that stores the user's hyperlinks to a user account, that when accessed by the user renders the hyperlinks on a webpage as icon images. The hyperlinks are made accessible on any device or browser that the user may utilize. The system and method provides transverse compatibility between browsers and devices, while maintaining a high level of functionality; in conjunction with ease of use.

The system allows a user to create an index of all of their favorite hyperlinks for their personal use, or the index may be shared with a group. The index, which can be accessed on any device or browser, is rendered as icon images in the web browser or application, by utilizing image values based on the domain name structure for the provided hyperlink, to retrieve an icon image from a database of images, wherein the plurality of images are given unique values in the database by the domain name structure for the given hyperlink representation.

The system includes a device with the capability to browse the internet; one or more hyperlinks, such as URLs, for one or more favorites which the user utilizes to browse the internet; and a non-transitory computer-readable medium that includes a database of images to provide a graphical representation of a corresponding one or more websites or webpages. The images within this database are given values based on the given hyperlink's graphical representation's domain name structure and are used to present the hyperlinks as icon images.

The system software is utilized with a web browser to access a page on the Internet, and only requires a device with the capability to browse the internet, meaning that the device should be able to control on screen cursor activity, as well as have keyboard functionality, that is input controls operable by the user. When the user accesses a selected web page online that is associated with their account information, a plurality of hyperlinks which they want to browse the internet with may be presented in the browser. The user is able to populate their browser by entering their selected hyperlinks into the content management system. The hyperlinks will be rendered as icon images, where the icon image values provided, are given values in relation to the domain name structure of the corresponding hyperlink, and are utilized to retrieve an icon image from an image database of hyperlink representations. The icon based web navigation platform is then available on any device or browser with the capability to browse the internet.

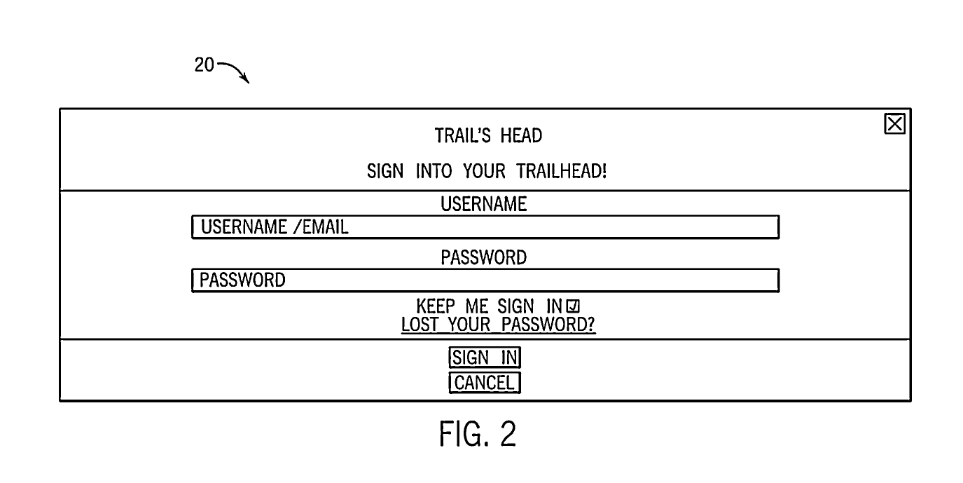

As seen in reference to FIG. 2, a non-limiting example of a web page browser associated with creating a new user account is shown for providing an authentication credential 20 for access to the system. By way of example, the authentication credential may include a username and password, a biometric access parameter, or other secure authentication process.

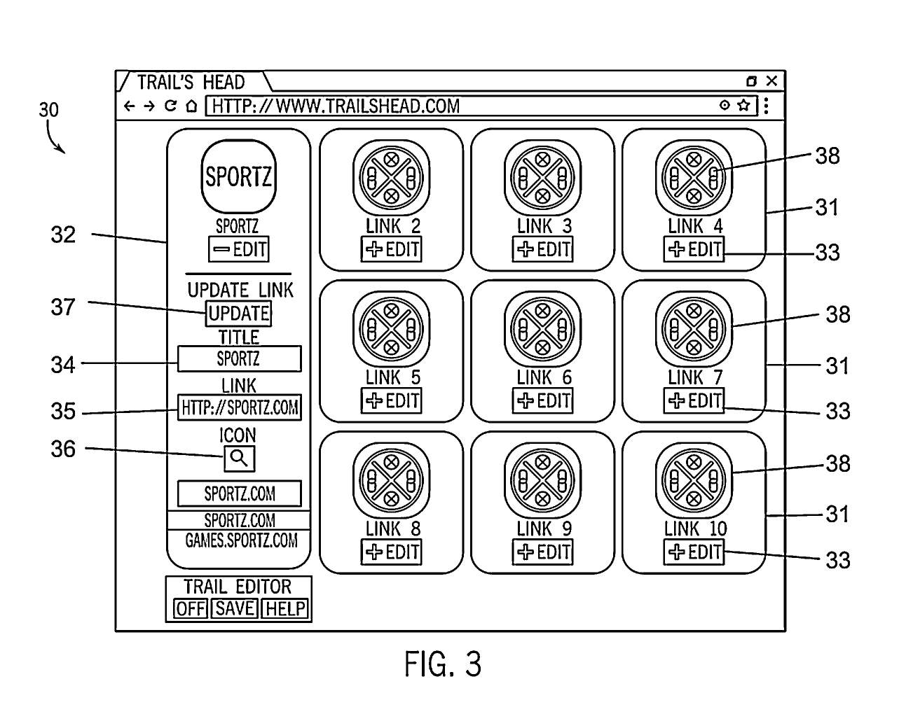

As seen in reference to FIG. 3, once the user has established an account and on later access the system, the user is presented a graphical user interface (GUI) in the image based browser window 30. The image based browser window 30 includes a plurality of framed hyperlink placeholders 31, disposed in a spaced apart relation. Once a user has their account established within the CMS, the user may personally select which hyperlinks they want saved, as well as the image values, and other attributes associated with the hyperlink. A hyperlink editor 32, is included in the GUI 30 that the user may use to edit and create a desired hyperlink, in order to populate the user interface with the plurality of selected hyperlinks 31 of interest to the user.

The hyperlink editor 32 may present the user with various setting options. The user may enable the hyperlink editor 32 with an editor control 33 provided on each of the plurality of selected hyperlink placeholders 31, by turning the editor on. When the user has selected the desired hyperlinks, the editor 32 may be turned off to prevent further editing of the hyperlinks. This may be useful when the user desires to share the selected hyperlinks with a group, but does not want other users accessing the page to edit or change the content. An information control may also be provided to permit or restrict the display of supplemental information pertaining to the selected hyperlinks 31.

A Link Editor Instruction page may be provided to assist the user in editing or populating the hyperlinks on the image based browser window 30 with the desired plurality of hyperlinks 31. In further reference to FIG. 3, if the hyperlink editor 32 is enabled, an editor control 33 is presented in each of the plurality of hyperlink placeholders 31. Upon selection of the editor control 33 within a selected placeholder 31, the user is presented various fields for designating and/or editing an icon based hyperlink to occupy the selected placeholder 31. The fields may include a Title field 34 for providing a textual description of the hyperlink. A link field 35 is provided for the user to enter the unified resource locator (URL) or other network address for a desired location to which the hyperlink placeholder 31 will correspond.

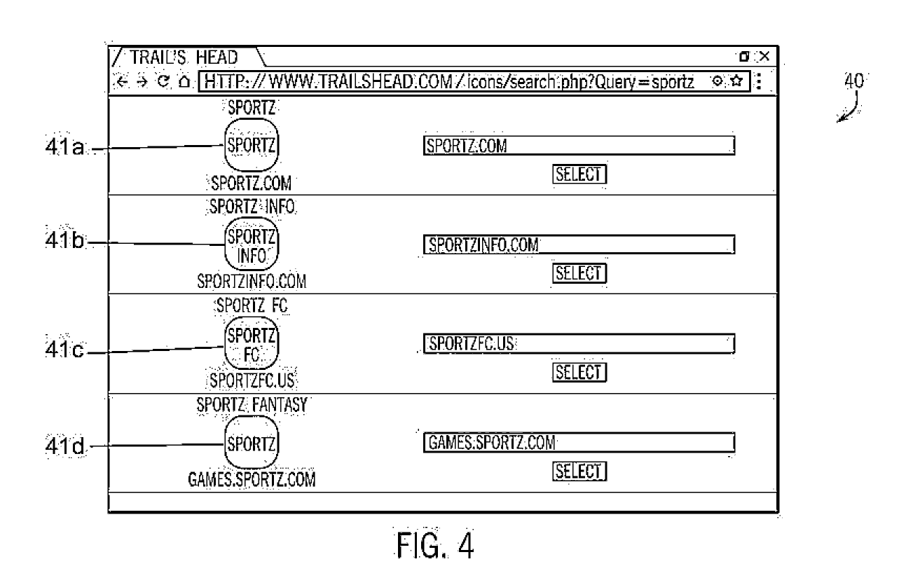

Once the user has entered a hyperlink location in the Link field 35, the user may also select an icon search control 36 presented in the editor 32. In response to activation of the icon search control 36, the system displays an icon database search page 40 for selecting an icon-image 41a-41d, such as shown in reference to FIG. 4, to be used within the content management system. The user can search for any icons 41a-d associated with the desired unified resource locator (URL) 35, as well as other default icon-image options (not shown). The images 41a-41d within this database are given values in relation to the domain name structure of the representation in order to establish a unique identifying image 41a-41d and value for any site or page icon image representation within the database. With this use of indexing, the CMS can then draw an image from the database of unique identifying images as a user enters a unified resource locator 35, by utilizing an image value based of the domain name structure of the given URL.

In the example provided, an entry of http://www.sportz.com, for a user selected desired location of a sports web site is used. To display an icon image for sportz.com, an input of sportz.com for an icon image value would be used, as the content management system utilizes the domain name structure of the given hyperlink to determine the hyperlink's icon image value, to draw icon image 41a, from the image database, as shown in FIG. 3.

In further reference to FIG. 4, a search for icon images with the value of sportz within the image name is shown. The search returns the results of icon images within the database of images, with the value of sportz in their name. As the icon images within the database are image representations of hyperlinks, given values in relation to their domain name structure, the database presents website icon image representations associated with the sportz search request, such as icon images for sportz.com; sportzinfo.com; sportzfc.us; games.sportz.com in the search window 40. The user could also select from a plurality generic icons from the image database as well (not shown). The generic icons may convey a visual representation that may be categorized for the user, such as a plurality of sports icons, a plurality of travel icons, and the like.

The icon images 41a-41d within the database may be populated based on a system retrieval of the domain name structure corresponding to the hyperlink 35. In further reference to FIG. 3, a hyperlink 35 of http://www.sportz.com, is used, and the domain name structure of the hyperlink is determined as sportz.com, which becomes the image value used to retrieve an icon image representation for this hyperlink, and returns icon image 41a to the icon based web browser hyperlink placeholder 31. If the user designates a hyperlink 35, and an icon image representation of that hyperlink does not exist in the database, the system may retrieve a generic icon associated with the designated hyperlink 35 from the image database for presentation in the search window 40.

In many instances, a particular domain may have a single unique icon representation of the site, regardless of the presence of any subdomains, country specific domains, or path within the URL. For example, as seen in further reference to FIG. 4, the URL, sportz.com has the same graphical icon 41a as the graphical icon 41d for the subdomain games.sportz.com. In other instances, the icons associated with the domain, subdomain, or other name structure may each have unique icons associated with each. Thus, the term unique icon, does not necessarily mean an icon that is different from all others, but merely that the destination hyperlink has an icon that is uniquely specified or associated to represent a particular destination.

The indexing within the system icon image database, and the associated search interface 40, which uses the domain name structure of the desired URL representation, permits the user to locate a desired site and image by typing a search term that may or may not correspond exactly to the desired URL. Because one or more associated domains, or subdomains may be presented in the search page 40, based on the context of the search, the user does not need to know the exact format of their intended destination URL in order to find and select a desired location representation for inclusion in their icon based web browser 30, such as icon images 41a-41d presented in the search page 40. Knowing the structure of the domain name itself for the desired hyperlink, allows for an icon image representation to be retrieved by the CMS, or selected by the user.

An opening behavior control may also be provided for the user to specify a behavior of the desired hyperlink. For example, the opening behavior instructs the browser to open the desired hyperlink in a new tab. The user may also specify that the browser open in a new browser window which launches a new browser instance. Alternatively, the opening behavior control may also specify to open in the current tab, in which case the current browser window is replaced with the contents of the selected icon based hyperlink. An update link control 37 may be provided to preview the specified desired hyperlink before it is saved to the user's account.

Once the user has saved the desired hyperlink 35, the user's browser interface 30 is populated with the icon representation 38 of the specified hyperlink, as seen in reference to FIG. 3. The title may also be displayed so that the user may know that the particular instance of the icon 38 is linked to the page designated in the title.

The CMS system is capable of holding a plurality of user accounts capable of holding unique user information within an account that is accessible by browsing the internet. The functionality is coded within that system to also save information about hyperlinks 35 and images 38 to represent those hyperlinks 35 based on the domain name structure of the hyperlinks 35.

Once the user has populated their web page 30 with their desired hyperlinks 31, they may choose to index the hyperlink placeholders so that they may be automatically organized on the user's web page 30. The hyperlink placeholders 31 may be indexed alphabetically, or may be grouped according to one or more categories, such as news, sports, travel, and the like. The user may want the ability to share their page and links with other users as they would with a social media platform.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A content management system (CMS) for providing a user configurable icon based browser user interface, comprising:
a server configured to serve web pages to a plurality of system users;
a database configured to store a plurality of hyperlinks for a plurality of web destinations and a unique icon image value associated with each of the plurality of hyperlinks, wherein plurality of icon images values for the hyperlinks are determined by the domain name structure of the hyperlink;
a database of icon images, used as representations of hyperlinks, given unique values based on the domain name structure of the given hyperlink.
an image based browser window presenting a graphical user interface having a plurality of hyperlink placeholders disposed in a spaced apart relation, wherein each of the plurality of hyperlink placeholders are user configurable to present a unique icon image from the icon image database, for a selected one of the plurality of hyperlinks, based off the unique icon image value of the hyperlink placeholder, determined by the domain name structure of the hyperlink of the placeholder, that when selected connects the user to the selected web destination corresponding to the hyperlink.

2. The CMS of claim 1, further comprising:
a method of retrieving the unique icon images from the image database by using the unique icon image values provided within the specified hyperlink placeholder within the image based browser window.

3. The CMS of claim 1, further comprising:
a link editor control in each of the plurality of hyperlink placeholders, that when activated, displays a link editor on the graphical user interface, the link editor providing controls for the user to designate a hyperlink and unique icon image value for the selected hyperlink placeholder.

4. The CMS of claim 3, wherein the link editor provides a plurality of fields for designating a user selected hyperlink and an icon control to specify the unique icon value for association with the selected hyperlink placeholder.

5. The CMS of claim 4, the link editor further comprising:
an update control, that when activated stores the selected icon image value used for display in the selected hyperlink placeholder of the image based browser and provides a control, that when selected by the user opens the web destination specified by the hyperlink corresponding to the selected icon image.

6. The CMS of claim 5, wherein the database is updated with a current hyperlink and unique icon value for the selected hyperlink upon activation of the update control.

7. The CMS of claim 1, wherein, responsive to activation of a share control, the user may share a configured image based browser with one or more users of the CMS.

8. The CMS of claim 1, wherein, responsive to activation of an off control, the edit control in each of the one or more placeholders is disabled.
